(19) United States
(12) Patent Application Publication
(10) Pub. No.: US 2004/0034972 A1
(43) Pub. Date: Feb. 26, 2004

(54) Rope-securing device

(76) Inventor: Jason Aaron Brown, Clinton, TN (US)

Correspondence Address: MICHAEL E. McKEE, Attorney at Law, 804 Swaps Lane, Knoxville, TN, 37923, US

(21) Appl. No.: 10/644,316

(22) Filed: Aug. 20, 2003

Related U.S. Application Data
(60) Provisional application No. 60/405,841, filed on Aug. 26, 2002.

(51) Int. Cl. F16G 11/00

(52) U.S. Cl. 24/129 R

(57) ABSTRACT

A device for securing two sections of rope together includes a body having a first plurality of through-openings through which one section of a rope can be threaded and a second plurality of through-openings through which another section of rope can be threaded to thereby secure the sections of rope in a fixed positional relationship with one another. The device is particularly well-suited for use to suspend a boat fender from the side of a boat.

The benefit of Provisional Application Ser. No. 60,405,841, filed Aug. 26, 2002 and entitled ROPE-SECURING DEVICE, is hereby claimed. The disclosure of this referenced provisional application is incorporated herein by reference.

### BACKGROUND OF THE INVENTION

This invention relates generally to marine accessories and relates, more particularly, to a device for securing two sections of rope together in a marine environment without knotting the rope.

To suspend a boat fender from a side of a boat, one end of a rope is tied to the boat fender and the other end is commonly tied to the rail of a boat so that the boat fender hangs suspended from the rail of the boat by the rope. Heretofore, the rope is knotted to effect the desired tie at the boat rail, and such knotting can permanently disfigure the rope and render the rope (with knots tied therein) with an unattractive appearance. It would be desirable to provide a means for securing the rope to the rail of the boat so that the boat fender is securely attached to the boat rail and wherein the means for securing is relatively attractive in appearance.

Accordingly, it is an object of the present invention to provide a new and improved device for securing two sections of a rope together without requiring that a knot be tied in the rope sections.

Another object of the present invention is to provide such a device which is uncomplicated in construction yet effective in operation.

Yet another object of the present invention is to provide such a device which is particularly well-suited for use in a marine environment to suspend a boat fender alongside a boat.

### SUMMARY OF THE INVENTION

This invention resides in a device for securing two sections of rope together.

The device includes a first set of through-openings through which one section of rope can be threaded and a second set of through-openings through which another section of rope can be threaded so that by threading the first and second sections of rope through the corresponding sets of through-openings, the one and another sections of rope are secured to one another.

### BRIEF DESCRIPTION OF THE DRAWINGS

FIG. 1 is a perspective view of one embodiment of the device.

FIG. 2 is a perspective view of the FIG. 1 embodiment shown being used to secure sections of a rope in a fixed positional relationship with one another.

FIG. 3 is a longitudinal cross-sectional view taken about line 3-3 of FIG. 2.

FIG. 4 is a perspective view of another embodiment of the device.

FIG. 5 is a perspective view of still another embodiment of the device.

### DETAILED DESCRIPTION OF THE ILLUSTRATED EMBODIMENT

Turning now to the drawings in greater detail and considering first FIG. 1, there is shown an embodiment of a device, generally indicated 10, for securing two sections of rope in a fixed positional relationship with respect to one another. To this end, the device 10 includes a body within which a plurality of openings, or holes, are formed through which two sections of rope (or two sections of two ropes) can be threaded.

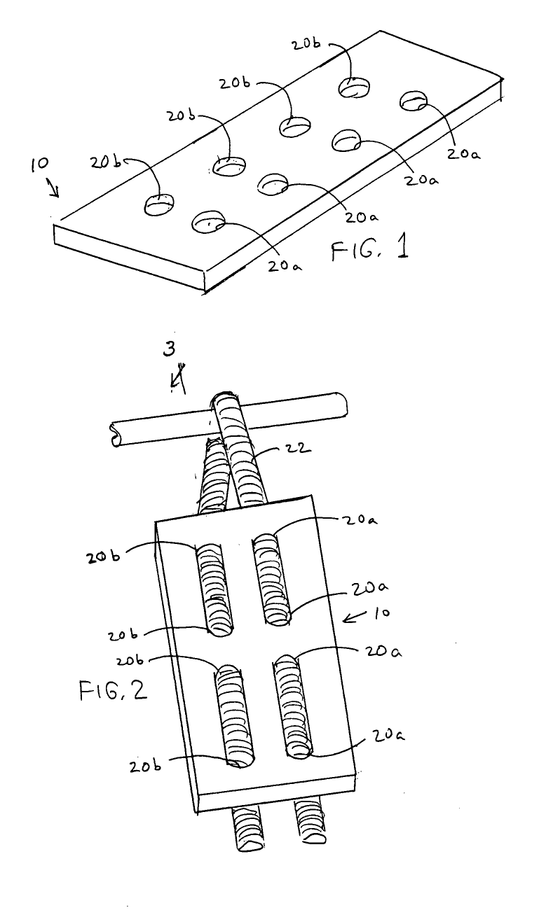

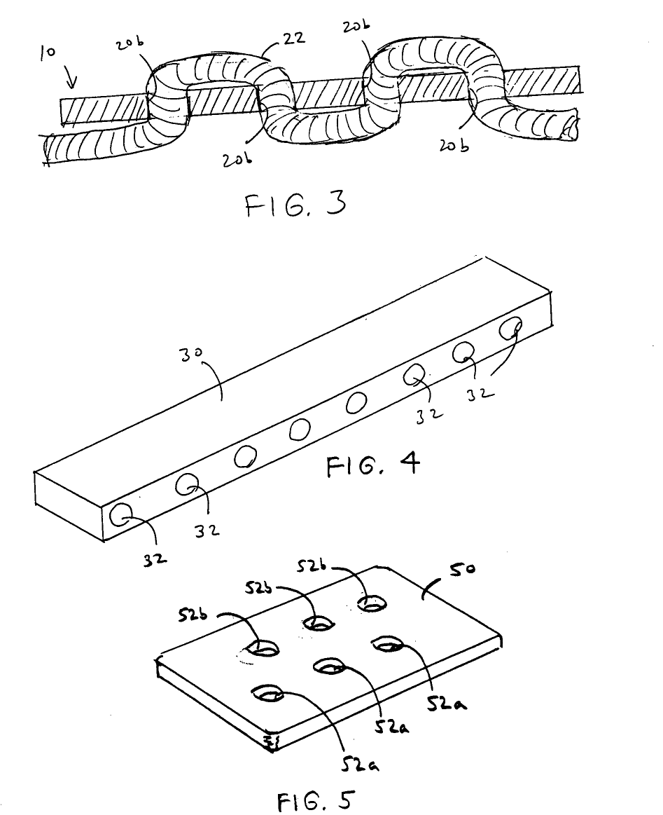

More particularly, the body 10 is in the form of a plate having two opposite side faces and includes a first set of holes, indicated 20a, through which one section of a rope 22 (FIGS. 2 and 3) can be threaded and includes a second set of holes, indicated 22b, through which another section of a rope can be threaded. The holes 22a, 22b in each set are regularly spaced and arranged along a linear path and are sized to closely accept the sections of rope to be threaded therethrough. Accordingly, the diameter of the holes 20a, 20b in the device body 10 closely approximates (i.e. is about equal to) the diameter of the rope sections to be threaded therethrough. Furthermore, the edges of the hole openings are smoothed or slightly beveled to reduce any likelihood that a rope section which is threaded through the holes will be cut, or otherwise damaged, by the edge of the hole openings.

Although the holes 22a, 22b in each set of holes in the depicted embodiment 10 of FIG. 1 are illustrated as being along a linear path, the holes can be positioned along a non-linear path. Accordingly, the principles of the present invention can be variously applied.

By threading one section of a rope 22 through one set of holes 22a and then threading another section of the rope through the second set of holes 22b, the rope sections are fixed in position with respect to one another at the device 10—even though the rope sections may be pulled in opposite directions (e.g. to a taut condition). It is believed that the rope sections are prevented from being pulled out of the holes 20a, 20b of the device 10 when the rope sections are pulled in opposite directions by virtue of the frictional gripping engagement between the surface of the rope sections and the surfaces (and edges) of the holes. The tortuous path (i.e. the in-and-out path) along which the rope sections follow through the device body 10 and as illustrated in FIGS. 2 and 3, promoted by the closeness of the spacing between the holes in each set of the device body 10, are also believed to enhance the resistance of the rope sections from being dislodged from their threaded, stationary condition within the device 10.

Along the same lines, the holes in each set are preferably apart by a distance which corresponds generally to (i.e. is about equal to) the thickness of the section of rope intended to be threaded therein. Accordingly, for use with a rope whose diameter was about 0.5 inches in thickness, the holes 22a, 22b in each set of holes of the device are spaced about 0.5 inches apart. For use with ropes of greater thickness, the holes in each set of the device would be spaced further apart.

An advantage provided by the device 10 relates to the fact that the rope sections do not need to be knotted in order to fixedly secure the rope sections in a fixed positional relationship (in the vicinity of the device 10) with respect to one another. Therefore, the device circumvents any need for the formation of knots which could permanently deform the rope.

Another advantage provided by the device 10 relates to the esthetics thereof. In particular and with reference to FIG. 2, the device 10, along with the rope sections threaded therethrough, is relatively pleasing to look at and is much more attractive than a rope within which one or several knots have been tied.

The device 10 can be used for suspending a boat fender from the side of a boat, but other uses of the device can be had wherein two sections of rope are desired to be fixed in a positional relationship with respect to one another. Accordingly, the principles of the invention can be variously applied.

Exemplary dimensions of the device 10 are as follows: The length and width dimensions of each side face of the device measure 4.0 inches by 2.75 inches, the thickness of the body of the device is about 0.375 inches, spacing between the holes in each set of holes is about 0.5 inches. Just as the spacing between adjacent holes in each set of holes corresponds to the thickness of the rope section to be threaded through the holes, the thickness of the device does as well. In other words, the thicker the rope section to be threaded through the device, the thicker the device.

It will be understood that numerous modifications and substitutions can be had to the aforedescribed embodiments without departing from the spirit of the invention. For example, although the device 10 of FIGS. 1-3 has been shown and described as being constructed so that the holes 20a, 20b formed therein extend between and open out of the opposite side faces of the device, a device in accordance with the present invention can be constructed so that the holes formed therein extend between the edges of the body thereof, such as is illustrated by the device 30 of FIG. 4 having through-holes which open out of the edge of the body of the device 30.

Further still, although the depicted device 10 of FIGS. 1-3 has been shown and described as including sets of holes having four holes each, a device can have an alternative number of holes in each set. For example, there is illustrated in FIG. 5 an embodiment 50 having two sets of holes 52a, 52b comprised of three holes in each set. Accordingly, the aforedescribed embodiments are intended for the purpose of illustration and not as limitation.

1. A device for securing two sections of rope together, the device comprising:
a body defining a first set of through-openings through which one section of rope can be threaded and a second set of through-openings through which another section of rope can be threaded so that by threading the first and second sections of rope through the corresponding sets of through-openings, the one and another sections of rope are secured to one another.

2. The device as defined in claim 1 wherein the body has two opposite side faces and the through-openings of each set open out of the opposite side faces of the body.

3. The device as defined in claim 1 wherein the body is in the form of a plate having two opposite side faces, and the through-openings of each set extend between the opposite side faces of the body.

4. The device as defined in claim 1 wherein each set of through-openings includes at least three through-openings.

5. The device as defined in claim 4 wherein the through-openings in each set are positioned along a linear path.

6. The device as defined in claim 1 wherein the through-openings of each set are positioned relatively close together so that when a corresponding section of rope is threaded through the through-openings of the set, the rope follows a relatively tortuous path.

7. The device as defined in claim 6 wherein the through-openings of each set are spaced apart by a distance which corresponds generally to the thickness of the rope section to be threaded through the through-openings of the set.

8. The device as defined in claim 6 wherein the through-openings of each set have diameters which are about equal to the diameter of the rope section to be threaded through the through-openings of the set.

9. A device for securing two sections of a rope together, the device comprising:
a body having two opposite side faces and defining a first set of through-openings which open out of the side faces and through which one section of rope can be threaded and a second set of through-openings which open out of the side faces and through which another section of rope can be threaded so that by threading the first and second sections of rope through the corresponding sets of through-openings, the one and another sections of rope are secured in a fixed positional relationship with one another.

10. The device as defined in claim 9 wherein the body has two opposite side faces and the through-openings of each set open out of the side faces of the body.

11. The device as defined in claim 9 wherein the body is in the form of a plate having two opposite side faces, and the through-openings of each set extend between the side faces of the body.

12. The device as defined in claim 9 wherein each set of through-openings includes at least three through-openings.

13. The device as defined in claim 9 wherein the through-openings in each set are positioned along a linear path.

14. The device as defined in claim 9 wherein the through-openings of each set are positioned relatively close together so that when a corresponding section of rope is threaded through the through-openings of the set, the rope follows a relatively tortuous path.

15. The device as defined in claim 14 wherein the through-openings of each set are spaced apart by a distance which corresponds generally to the thickness of the rope section to be threaded through the through-openings of the set.

16. The device as defined in claim 14 wherein the through-openings in each set are about 0.5 inches apart.

17. The device as defined in claim 13 wherein the body of the device has a thickness as measured between the two side faces which is about 0.375 inches.

18. The device as defined in claim 9 wherein the through-openings of each set have diameters which are slightly larger than those of the rope sections to be threaded through the through-openings.

19. The device as defined in claim 9 wherein the body of the device is in the form of a rectangular platen.
